(19) United States
(12) Patent Application Publication
(10) Pub. No.: US 2013/0266174 A1
(43) Pub. Date: Oct. 10, 2013

(54) SYSTEM AND METHOD FOR ENHANCED OBJECT TRACKING

(71) Applicants: Amit Bleiweiss, Yad Binyamin (IL); Shahar Fleishman, Hod Hasharon (IL); Gershom Kutliroff, Alon Shvut (IL)

(72) Inventors: Amit Bleiweiss, Yad Binyamin (IL); Shahar Fleishman, Hod Hasharon (IL); Gershom Kutliroff, Alon Shvut (IL)

(73) Assignee: Omek Interactive, Ltd.

(21) Appl. No.: 13/441,271

(22) Filed: Apr. 6, 2012

(51) Int. Cl. G06K 9/62

(52) U.S. Cl. 382/103

(57) ABSTRACT

A system and method are provided for object tracking using depth data, amplitude data and/or intensity data. In some embodiments, time of flight (ToF) sensor data may be used to enable enhanced image processing, the method including acquiring depth data for an object imaged by a ToF sensor; acquiring amplitude data and/or intensity data for an object imaged by a ToF sensor; applying an image processing algorithm to process the depth data and the amplitude data and/or the intensity data; and tracking object movement based on an analysis of the depth data and the amplitude data and/or the intensity data.

### BACKGROUND

There is a need for enhanced ways for people to interact with technology devices and access their varied functionality, beyond the conventional keyboard, mouse, joystick etc. Ever more powerful computing and communication devices have further generated a need for effective tools for inputting text, choosing icons, manipulating objects. This need is even more noticeable for small devices, such as mobile phones, personal digital assistants (PDAs) and hand-held consoles, which do not have room for a full keyboard.

Significant advances have been made in recent years in the application of gesture control for user interaction with electronic devices. Gestures can be used, for example, to control a television, for home automation, to interfaces with tablets, personal computers, and mobile phones. As core technologies continue to improve and their costs decline, gesture control is destined to continue to play a major role in the ways in which people interact with electronic devices. The ability to accurately recognize a user's gestures depends on the quality and accuracy of the core tracking capabilities.

Furthermore, there is a need to more accurately identify the movements of people and objects. For example, in the field of vehicle safety systems, it would be beneficial to have a system that is able to better identify objects outside the vehicle, such as pedestrians and other automobiles, and track their movements. In the surveillance industry, there is a need to more accurately identify the movements of people in a (possibly prohibited) area.

### BRIEF DESCRIPTION OF THE DRAWINGS

Examples of a system for automatically defining and identifying movements are illustrated in the figures. The examples and figures are illustrative rather than limiting.

FIGS. 1A and 1B are schematic diagrams illustrating example components of an object sensing system, according to some embodiments.

FIG. 2 is a flow diagram illustrating an example of a process of amplitude assisted object tracking, according to some embodiments.

FIGS. 3A and 3B are flow diagrams illustrating examples of an amplitude assisted object tracking, according to some embodiments.

FIG. 3C shows several photographs illustrating an example of object tracking using amplitude and depth data, according to some embodiments.

FIG. 4 is a flow diagram illustrating an example of amplitude assisted object tracking, according to some embodiments.

### DETAILED DESCRIPTION

A system and method are provided for object tracking using depth data and amplitude data, depth data and intensity data, or depth data and both amplitude data and intensity data. Time of flight (ToF) sensor data may be used to provide enhanced image processing, the method including acquiring depth data for an object imaged by a ToF sensor; acquiring amplitude data for the imaged object and/or acquiring intensity data for the imaged object; applying an image processing algorithm to process the depth data and the amplitude data and/or the intensity data; and tracking object movement based on an analysis of the depth data and the amplitude data and/or the intensity data.

Various aspects and examples of the invention will now be described. The following description provides specific details for a thorough understanding and enabling description of these examples. One skilled in the art will understand, however, that the invention may be practiced without many of these details. Additionally, some well-known structures or functions may not be shown or described in detail, so as to avoid unnecessarily obscuring the relevant description.

The terminology used in the description presented below is intended to be interpreted in its broadest reasonable manner, even though it is being used in conjunction with a detailed description of certain specific examples of the technology. Certain terms may even be emphasized below; however, any terminology intended to be interpreted in any restricted manner will be overtly and specifically defined as such in this Detailed Description section.

The tracking of object movements as may be performed, for example, by an electronic device responsive to gestures, requires the device to be able to recognize the movements or gesture(s) that a user or object is making. For the purposes of this disclosure, the term ‘gesture recognition’ is used to refer to a method for identifying specific movements or pose configurations performed by a user, such as a swipe on a mouse-pad in a particular direction having a particular speed, a finger tracing a specific shape on a touchscreen, or the wave of a hand. The device must decide whether a particular gesture was performed or not by analyzing data describing the user's interaction with a particular hardware/software interface. That is, there must be some way of detecting or tracking the object that is being used to perform or execute the gesture. In the case of a touchscreen, it is the combination of the hardware and software technologies necessary to detect the user's touch on the screen. In the case of a depth sensor-based system, it is generally the hardware and software combination necessary to identify and track the user's joints and body parts.

In the above examples of device interaction through gesture control, as well as object tracking in general, a tracking layer enables movement recognition and tracking. In the case of gesture tracking, gesture recognition may be distinct from the process of tracking, as the recognition of a gesture triggers a pre-defined behavior (e.g., a wave of the hand turns off the lights) in an application, device, or game that the user is interacting with.

The input to an object tracking system can be data describing a user's movements that originates from any number of different input devices, such as touch-screens (single-touch or multi-touch), movements of a user as captured with an RGB (red, green, blue) sensor, and movements of a user as captured using a depth sensor. In other applications, accelerometers and weight scales can provide useful data for movement or gesture recognition.

U.S. patent application Ser. No. 12/817,102, entitled “METHOD AND SYSTEM FOR MODELING SUBJECTS FROM A DEPTH MAP”, filed Jun. 16, 2010, describes a method of tracking a player using a depth sensor and identifying and tracking the joints of a user's body. U.S. patent application Ser. No. 12/707,340, entitled “METHOD AND SYSTEM FOR GESTURE RECOGNITION”, filed Feb. 17, 2010, describes a method of identifying gestures using a depth sensor. Both patent applications are hereby incorporated in their entirety in the present disclosure.

Robust movement or gesture recognition can be quite difficult to implement. In particular, it needs to be able to interpret the user's intentions accurately, take into account differences in movement between different users, and determine the context in which the movements are active.

The above described challenges further emphasize the need for enhanced accuracy, speed and intelligence when sensing, identifying and tracking objects or users. Enhanced tracking may be used to enable movement recognition, and can also be applied to provide enhancements for surveillance applications (for example, using three-dimensional sensors and the techniques described herein for tracking people moving around in a space, applying this to people counting, or tailgating, etc.), or further applications where monitoring people and understanding their movements is beneficial. Furthermore, there is a need for enabling object tracking in different conditions, such as darkness, where enhanced movement tracking is necessary even under problematic conditions.

The present disclosure describes the usage of depth, amplitude and intensity data to help track objects, thereby helping to more accurately identify and process user movements or gestures.

### TERMINOLOGY

Object Tracking System.

An object tracking system needs to recognize and identify movements performed by a user or object being imaged, and to interpret the data to determine movements, signals or communication.

Gesture Recognition System.

A gesture recognition system is a system that recognizes and identifies pre-determined movements performed by a user in his or her interaction with some input device. Examples include interpreting data from a sensor or camera to recognize that a user has closed his hand, or interpreting the data to recognize a forward punch with the left hand.

Depth Sensors.

The present disclosure may be used for object tracking based on data acquired from depth sensors, which are sensors that generate three-dimensional data. There are several different types of depth sensors, such as sensors that rely on the time-of-flight principle, structured light, coded light, speckled pattern technology, and stereoscopic cameras. These sensors may generate an image with a fixed resolution of pixels, where each pixel has an integer value, and the values correspond to the distance of the object projected onto that region of the image by the sensor. In addition to this depth data, the depth sensors may be combined with conventional color cameras, and the color data can be combined with the depth data for use in processing.

Gesture.

A gesture is a unique, clearly distinctive motion or pose of one or more body joints or parts. The process of gesture recognition analyzes input data to determine whether a gesture was performed or not.

Classifier.

A process that identifies a given motion, for example by identifying a specific movement as a target gesture, or rejecting the motion if it is not identified as a target gesture.

Input Data.

The data generated by a depth sensor, and used as input into the tracking algorithms. For example, this data may be the depth sensor's representation of the capture of an object's or user's movements in front of the sensor.

ToF Sensor.

Time-of-Flight (ToF) technology, based on measuring the time that light emitted by an illumination unit requires to travel to an object and back to the sensor.

The present disclosure may be used for object tracking, whether of people, animals, vehicles or other objects, based on depth, amplitude and/or intensity data acquired from depth sensors. Amplitude (a), as used herein, may be defined, in some embodiments, according to the following formula. According to the time of flight principle, the correlation of an incident optical signal, s, with a reference signal, g, that is the incident optical signal reflected from an object, is defined as:

$$C ( τ ) = s ⊗ g = {lim}_{T -> ∞} {\int }_{- T / 2}^{T / 2} s ( t ) \cdot g ( t + τ ) d t .$$

For example, if g is an ideal sinusoidal signal, fₘ is the modulation frequency, a is the amplitude of the incident optical signal, b is the correlation bias, and φ is the phase shift (corresponding to the object distance), the correlation would be given by:

$$C ( τ ) = \frac{a}{2} cos ( {f}_{m} τ + ϕ ) + b .$$

Using four sequential phase images with different phase offsets:

$$τ : {A}_{i} = C ( i \cdot \frac{π}{2} ) , i = 0 , … , 3 :$$

The phase shift, the intensity, and the amplitude of the signal can be determined:

$$φ = arc tan 2 ( {A}_{3} - {A}_{1} , {A}_{0} - {A}_{2} ) , \\ I = \frac{{A}_{0} + {A}_{1} + {A}_{2} + {A}_{3}}{4} , \\ a = \frac{\sqrt{{( {A}_{3} - {A}_{1} )}^{2} + {( {A}_{0} - {A}_{2} )}^{2}}}{2} ,$$

In practice, the input signal may be different from a sinusoidal signal. For example, the input may be a rectangular signal. Then the corresponding phase shift, intensity, and amplitude would be different from the idealized equations presented above.

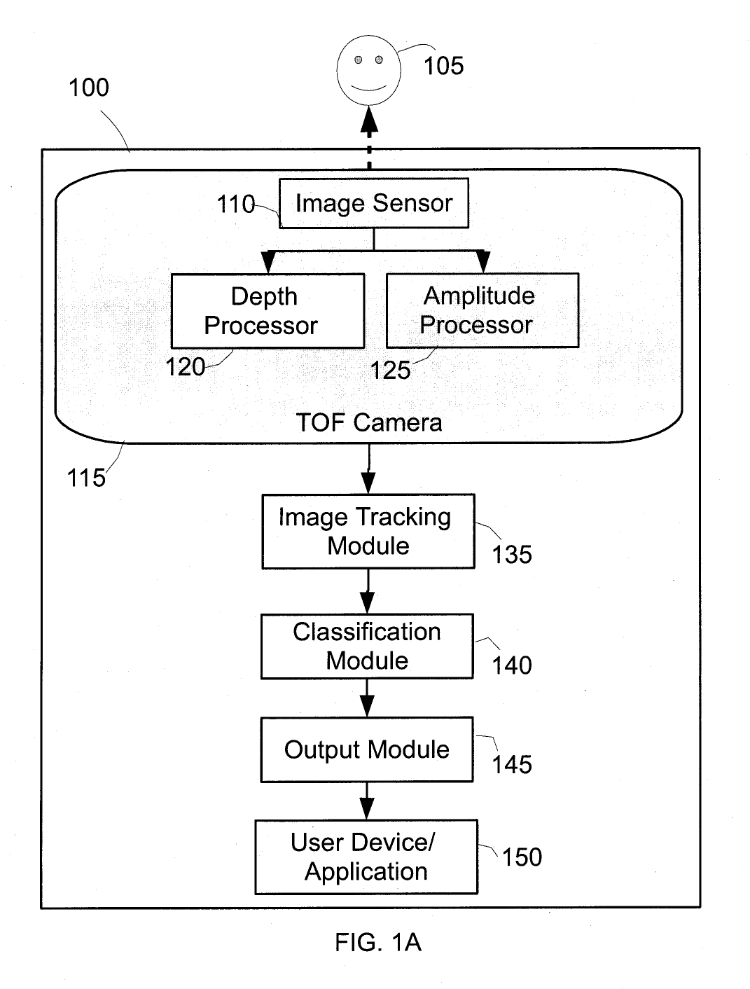

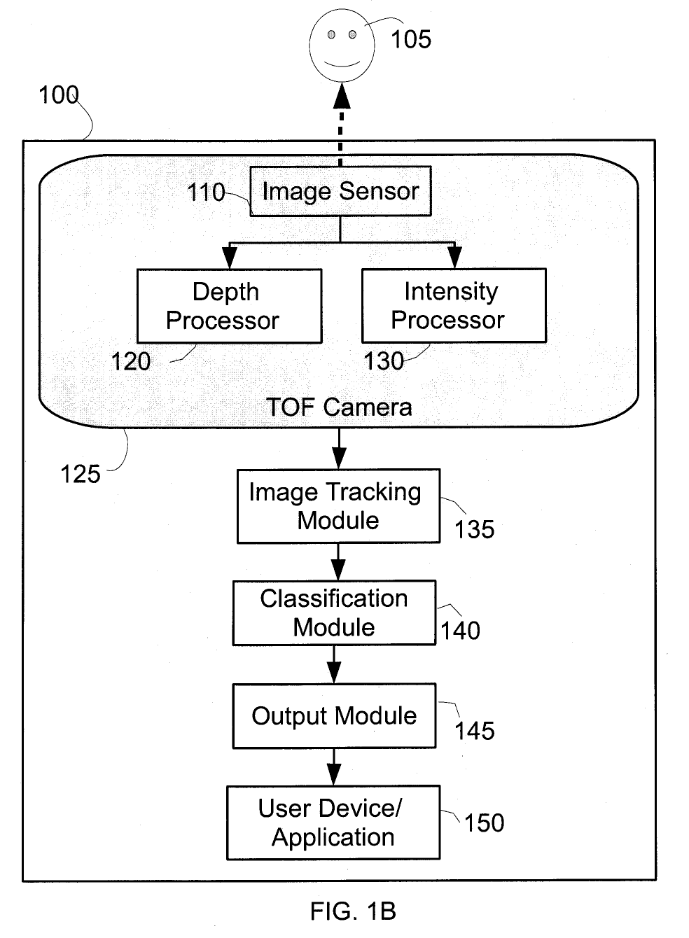

Reference is now made to FIG. 1A, which is a schematic illustration of example elements of an object tracking system, and the work flow between these elements, in accordance with some embodiments. As can be seen in FIG. 1A, system 100 can track an object 105, such as a user, vehicle, player of a game, etc., where the object 105 is typically located in the range of the system sensors. System 100 can include a Time of Flight (ToF) sensor 115, an image tracking module 135, a classification module 140, an output module 145, and/or a user device/application 150. The ToF sensor 115 can include an image sensor 110, a depth processor 120, and an amplitude processor 125. The image sensor 110 or camera senses objects, such as object 105. The image sensor 110 can be an image camera, a depth sensor, or other sensor devices or combinations of sensor devices.

The ToF sensor 115 can further include a depth processor module 120, which is adapted to process the received image signal and generate a depth map. The ToF sensor 115 can further include an amplitude processor module 125, which is adapted to process the received image signal and generate an amplitude map. As can be seen with reference to FIG. 1B, The ToF sensor 115 can include an intensity processor module 130 instead of the amplitude processor module 125. The intensity processor module 130 is adapted to process the received image signal and generate an intensity map. In one embodiment, the ToF sensor 115 can include both the amplitude processor module 125 and the intensity processor module 130. Amplitude and/or intensity data may be used, for example, to help identify objects or object movements in light challenged conditions, such as changing lighting conditions, even when well lit, the presence of shadows, and low lighting environments, or other situations where depth data alone may not suffice to provide the necessary object and movement sensing data. Furthermore, different image processing techniques may be effective for different types of data. For example, when processing an amplitude image, it may be useful to track the gradients (edges), which indicate sharp discontinuities between objects. When processing a depth image, it may be useful to threshold depth values to assist in segmenting foreground objects from the background.

System 100 may further include an image tracking module 135 for determining object tracking. In some embodiments a depth sensor processing algorithm may be applied by tracking module 135, and/or an amplitude sensor processing algorithm may be applied by tracking module 135, to enable system 100 to utilize both depth and amplitude data received from image sensor 110. In one example, the output of module 135, the tracking data, may correspond to the object's skeleton, or other features, whereby the tracking data can correspond to all of a user's joints or feature points as generated by the tracking module, or a subset of them. System 100 may further include an object data classification module 140, for classifying sensed data, thereby aiding in the determination of object movement. The classifying module may, for example, generate an output that can be used to determine whether an object is moving, gesticulating etc.

System 100 may further include an output module 145 for processing the processed gesture data to enable the data to be satisfactorily output to external platforms, consoles, etc. System 100 may further include a user device or application 150, on which a user may play a game, view an output, execute a function or otherwise make use of the processed movement data sensed by the depth sensor.

As can be seen with reference to FIG. 1B, depth data and intensity data, from intensity processor 130, may be used to help an object tracking system to more accurately identify and process object or user movements or gestures, such as 3D movements, in a similar way as to that described above with regards to amplitude data.

In accordance with further embodiments, amplitude and intensity data may be used to assist in tracking movements of joints or parts of objects or users, to help segment foreground from background for classification of images, to determine pose differentiation, to enable character detection, to aid multiple object monitoring, to facilitate 3D modeling, and/or perform various other functions.

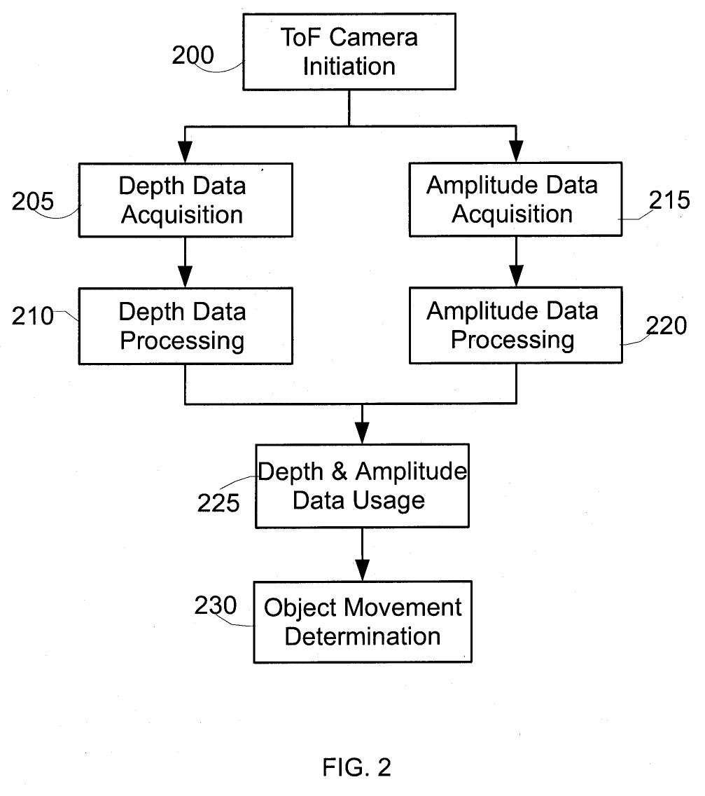

Reference is now made to FIG. 2, which is a flow diagram describing example steps or aspects in the object tracking process, in accordance with some embodiments. As can be seen in FIG. 2, at block 200, a TOF sensor may be initiated, to image movements of an object, such as a user. At block 205 the depth data may be acquired, and at 210 the depth data may be processed, for example, by a depth data processor or processing algorithm to identify movements of the object. In parallel to acquiring the depth data, at block 215 the amplitude data may also be acquired, and at 220 the amplitude data may be processed, for example, using an amplitude data processor or processing algorithm. At block 225 the processed depth data and the processed amplitude data may be used, alone or in combination, to classify image data, track objects, etc. For example, object segmentation can be performed on the depth and/or amplitude image data to identify objects of interest. In other examples, after object segmentation, relevant points in the image data may be identified and tracked, using a tracking module to process the image data from the depth sensor by identifying and tracking the feature points of the user, such as skeleton joints. In some cases, a classifier may be used to determine whether a movement was performed or not. In some cases the decision may be based, for example, on generated skeleton joints tracking data. In yet other examples, masks corresponding to imaged objects or other information from the object segmentation can be used for aiding motion or gesture recognition. At block 230 the object identification may be used, for example, to enable object tracking, in consideration of the depth and amplitude data.

In some embodiments, intensity data may be used, in place of, or in addition to, amplitude data, as described above. Accordingly, an intensity data processing module may be used to process intensity data as may be necessary, as shown in FIG. 1B.

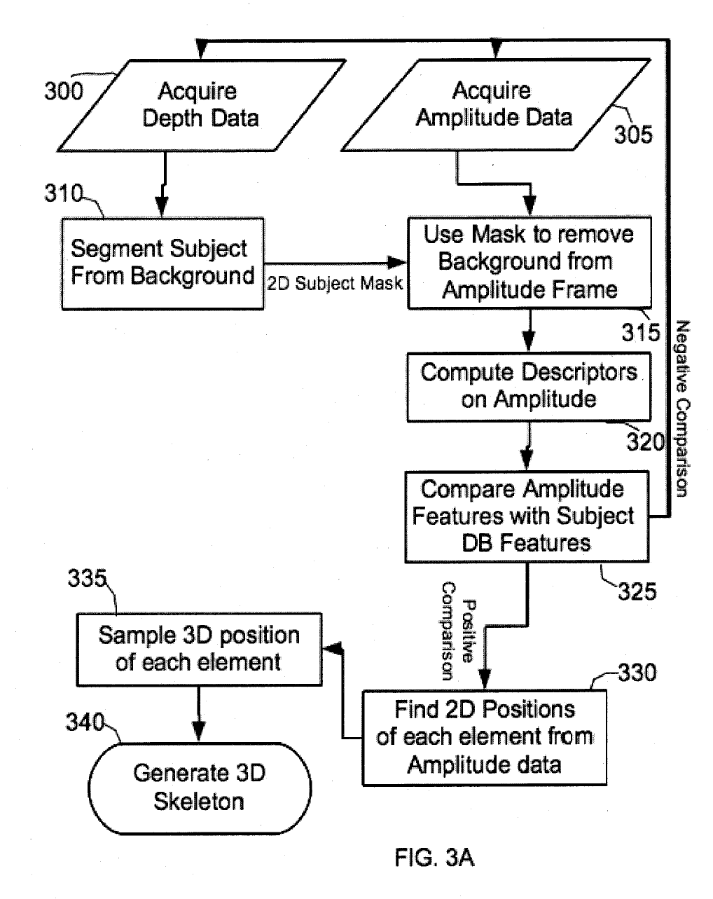

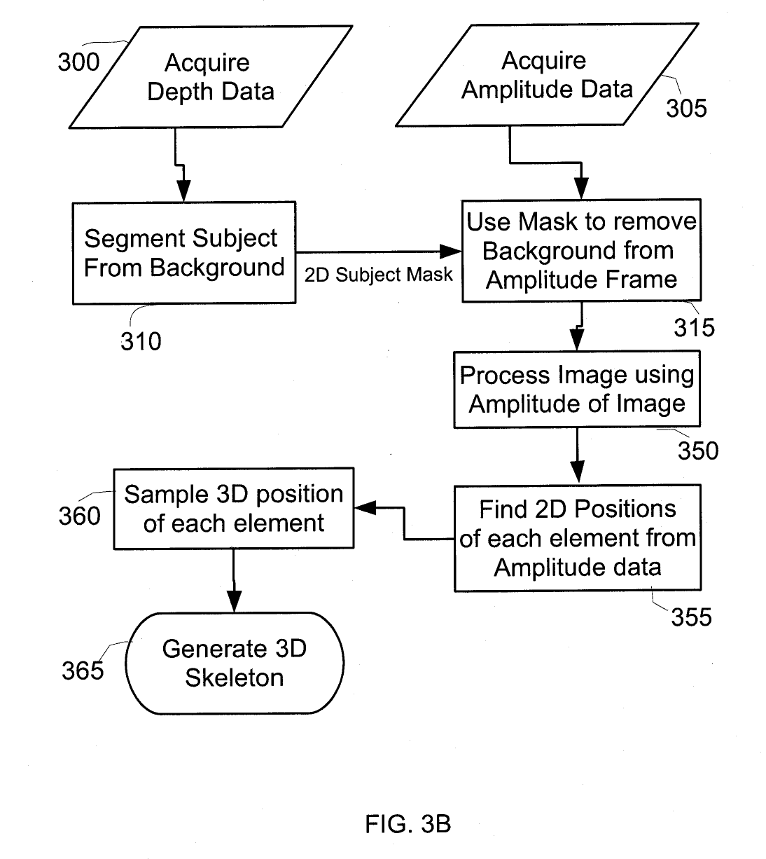

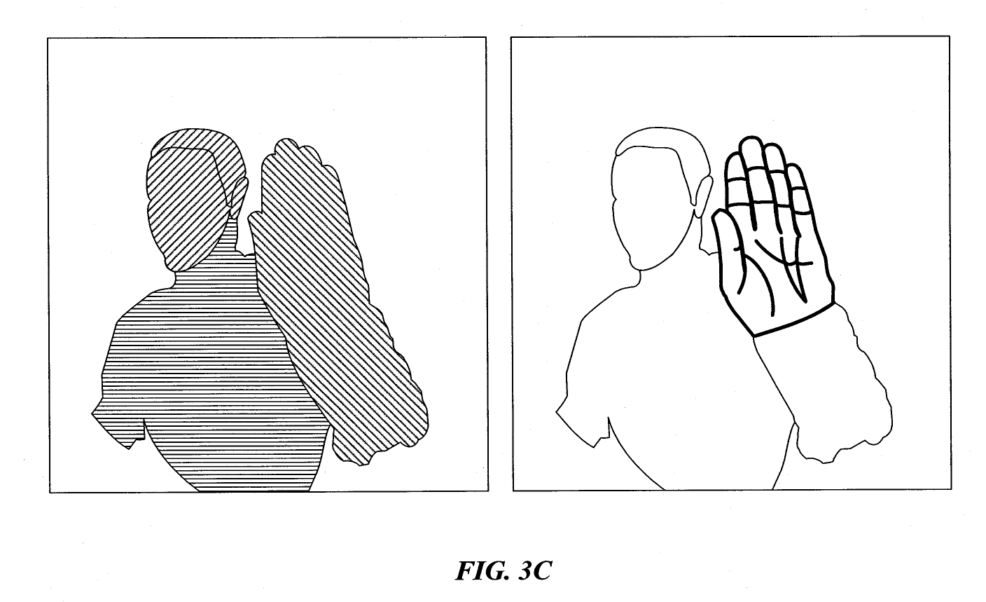

Reference is now made to FIG. 3A, which describes in a flow diagram an example of an object tracking sequence, according to some embodiments. As can be seen in FIG. 3A, at block 300 the depth process module may acquire a signal from the image sensor 110 and generate the depth data. At block 305 the amplitude processor module may acquire the signal from the image sensor 110 and generate the amplitude data. In some embodiments, an intensity processor module may acquire the signal and generate intensity data, in place of, or in addition to, the amplitude data.

At block 310, in some examples of implementation, initial image segmentation may be executed, to separate the object of interest from the background. In some examples, a data mask, for example a binary mask (A binary mask is an image where every pixel has a value of either 1 or 0, so the mask conveys the shape of the object, and each pixel is either on the object or part of the background.) or two-dimensional (2D) subject mask, may be created from the depth data. At block 315 the mask may be used, together with the amplitude data or received image, to remove background data or pixels from the amplitude frame. This is basically an “and” binary operation which, for example, interprets pixels above a certain threshold in the amplitude image that correspond to a value or one on a 2D subject mask as part of the object, and the rest of the pixels in the amplitude image correspond to the background. The result of the step at block 315 may be to generate a masked amplitude image, or an amplitude image where all pixels not corresponding to the object of interest are equal to 0.

At block 320, on the masked amplitude image, descriptors may be computed, which are features specific to the object of interest. For example, if the object of interest is a hand, the descriptors may be edges of the fingertips. At block 325 the descriptors found from the masked amplitude image may be compared to a database of subject features, for example, depth features. If the result of the comparison is not sufficiently similar, the object of interest has not been found. Thus, it is assumed that the object is not present in the acquired image. The system returns to acquire additional depth and amplitude data frames at blocks 300 and 305 to continue searching for the object of interest.

If the result of the comparison is sufficiently similar, the system may assume that the object of interest and its position have been identified. In such a scenario, at block 330, after the position of the object of interest has been identified, the masked amplitude image may be used to compute the 2D positions of each tracked element, such as the 2D positions of a joint or element, from the amplitude data.

At block 335 the 2D positions of each joint or element may be used to sample the 3D depth values from the depth image, since there is a one-to-one mapping between the depth image and the amplitude image. At block 340, the 3D positions of the joints may be used to generate a 3D skeleton. Furthermore, in some embodiments, intensity data may be used in place of, or in addition to, amplitude data, as described above.

Reference is now made to FIG. 3B, which describes in a flow diagram an example of an object tracking processing sequence, according to some embodiments. The processing sequence, in some implementations, may include a technique for using amplitude data and/or intensity data in conjunction with depth data to enable enhanced segmentation for object identification and tracking. According to some embodiments, data from different channels of the sensor may be combined, and consequently, the strengths of one channel can be used to compensate for the weaknesses of others. As can be seen in FIG. 3B, at block 300 the depth data processor module may acquire a signal from the image sensor 110 and generate the depth data. In parallel to acquiring the depth data, at block 305 the amplitude processor module may acquire the received signal and generate the amplitude data. Likewise, in further embodiments, an intensity processor module may acquire the received signal and generate intensity data, in place of, or in addition to, the amplitude data.

At block 310, in some examples of implementation, initial image segmentation may be executed, to separate the object of interest from the background. In some examples, a data mask, for example a binary mask or 2D subject mask, may be created from the depth data. At block 315 the mask may be used, together with the amplitude data or received image, to remove background data or pixels from the amplitude frame.

At block 350 the image may be processed using the amplitude data from the image, such that, at block 355, after the position of the object of interest has been identified, the masked amplitude image may be used to compute the 2D positions of each tracked element from the amplitude data. At block 360 the 2D positions of each joint or element may be used to sample the 3D depth values from the depth image. At block 365 the 3D positions of the joints may be used to generate a 3D skeleton. Furthermore, in some embodiments, intensity data may be used in place of, or in addition to, amplitude data, as described above.

In general, computer vision (or “image processing”) algorithms can accept different types of input data, such as depth data from active sensor systems (e.g., Time of Flight (TOF), structured light), depth data from passive sensor systems (e.g., such as stereoscopic), color data, amplitude data, etc. Amplitude, as described herein, relates specifically to the “amplitude of the incident optical signal”, which is substantially equivalent to the strength of the received signal in a TOF sensor system. The particular algorithms most effective for processing the data depend on the character of the data. For example, depth data is more useful when there is a sharp difference between objects that are adjacent in the image plane. On the other hand, depth data is less useful when the differences in the depth values of adjacent objects are smaller. RGB data is more useful when the environmental lighting is stable, and RGB data has the advantage of typically much higher resolution than the depth data obtained from active sensor systems. In a similar vein, the amplitude data has the disadvantage of low resolution, wherein the resolution is substantially equivalent to that of the depth data. However, the amplitude data is robust to environmental lighting conditions and typically contains a much higher level of detail than the depth data. Furthermore, in some embodiments, intensity data may be used in place of, or in addition to, amplitude data, as described above.

Similarly, different image processing techniques may be effective for different types of data. For RGB data, tracking can be done based on the color of objects. A common example is to use the color of the skin for tracking exposed parts of the human body. When processing an amplitude image, it may be useful to track the gradients (edges), which indicate sharp discontinuities between objects.

Reference is now made to FIG. 3C, which shows several photographs illustrating an example of object sensing, according to some embodiments. The left photograph shows a depth image in which each pixel value corresponds to the distance of the associated object from the sensor. The depth image can be displayed as either a grayscale image or color image. The left photograph, as depicted, is a grayscale image of the depth data where each pixel value corresponds to a different shade of gray, for example, larger depth values (farther object distances) are shown as darker shades of gray. Similarly, if the depth image were displayed as a color image, each pixel value of the depth image would correspond to a different color.

The center photograph shows the intensity image in which each pixel value corresponds to the intensity value I, as defined above. The right photograph shows the amplitude image in which each pixel value corresponds to the amplitude variable a, as defined above.

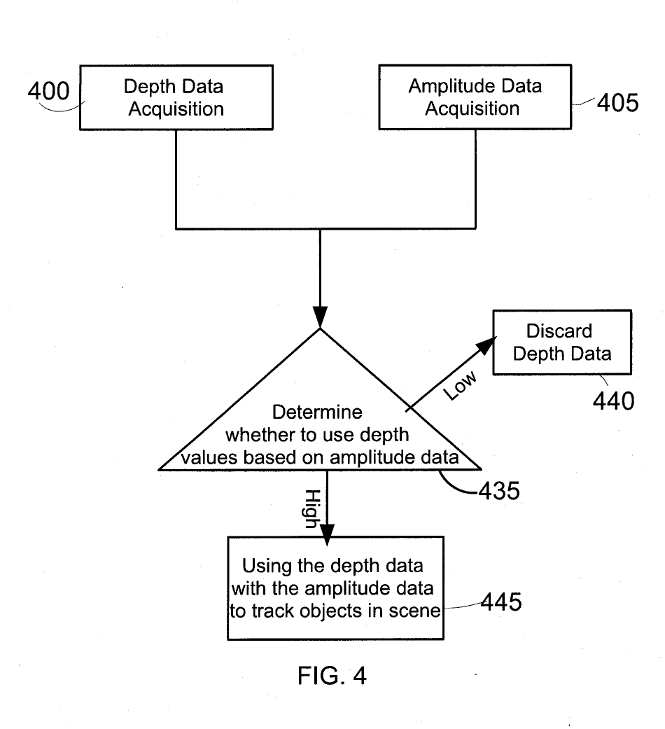

As can be seen in FIG. 4, a technique is herein described for using amplitude data to provide a confidence map or layer to enable enhanced object segmentation and/or object identification/tracking, using multiple signals to help deliver enhanced object tracking. In a ToF based system, image pixels corresponding to objects that return a weaker infrared (IR) signal—that is, less IR light—typically have less dependable depth values. In general, either the IR signal is reflected off of a material with low IR reflectance or the object is too far away from the camera's IR emitter. In both cases, the depth data obtained is typically less dependable and has noisier values. Since the values of the amplitude signal indicate the strength of the incident IR signal, the amplitude signal may also indicate the reliability of the depth data pixels.

According to some embodiments, data from different channels of the sensor may be combined, and consequently, the strengths of one channel can be used to compensate for the weaknesses of others. In one example, at block 400 the object tracking apparatus, platform or system may acquire and process depth data from a depth sensor. In parallel to block 400, at block 405 the object tracking apparatus, platform or system may acquire and process amplitude data from a depth sensor, where the amplitude signal value is determined on a per-pixel basis.

Because the amplitude data is assumed to provide an indication of the confidence level of the depth data values, at block 435, a decision is made whether to use the depth data based on the amplitude data values. If the amplitude signal value for a given pixel is determined to be substantially low, this indicates a low level of confidence in the accuracy of the pixel value, and at block 440, the depth data for the given pixel may be discarded. If the amplitude signal pixel value is determined to be substantially high, meaning that the amplitude level indicates a high level of confidence in the accuracy of the pixel value, then at block 445, the depth data and the amplitude data may be utilized to track objects in a scene. Alternatively, the depth data can be used by itself to track objects in a scene. Furthermore, in some embodiments, intensity data may be used in place of, or in addition to, amplitude data, as described above.

In the above described process, the amplitude signal is substantially “free”, that is, it may be computed as a component of the TOF calculations. Therefore, using this signal does not substantially add additional processing requirements to the system.

Unless the context clearly requires otherwise, throughout the description and the claims, the words “comprise”, “comprising”, and the like are to be construed in an inclusive sense (i.e., to say, in the sense of “including, but not limited to”), as opposed to an exclusive or exhaustive sense. As used herein, the terms “connected,” “coupled,” or any variant thereof means any connection or coupling, either direct or indirect, between two or more elements. Such a coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. While processes or blocks are presented in a given order in this application, alternative implementations may perform routines having steps performed in a different order, or employ systems having blocks in a different order. Some processes or blocks may be deleted, moved, added, subdivided, combined, and/or modified to provide alternative or sub-combinations. Also, while processes or blocks are at times shown as being performed in series, these processes or blocks may instead be performed or implemented in parallel, or may be performed at different times. Further any specific numbers noted herein are only examples. It is understood that alternative implementations may employ differing values or ranges.

The various illustrations and teachings provided herein can also be applied to systems other than the system described above. The elements and acts of the various examples described above can be combined to provide further implementations of the invention.

Any patents and applications and other references noted above, including any that may be listed in accompanying filing papers, are incorporated herein by reference. Aspects of the invention can be modified, if necessary, to employ the systems, functions, and concepts included in such references to provide further implementations of the invention.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

While certain aspects of the invention are presented below in certain claim forms, the applicant contemplates the various aspects of the invention in any number of claim forms. For example, while only one aspect of the invention is recited as a means-plus-function claim under 35 U.S.C. §112, sixth paragraph, other aspects may likewise be embodied as a means-plus-function claim, or in other forms, such as being embodied in a computer-readable medium. (Any claims intended to be treated under 35 U.S.C. §112, ¶6 will begin with the words “means for.”) Accordingly, the applicant reserves the right to add additional claims after filing the application to pursue such additional claim forms for other aspects of the invention.

We claim:

1. A method of using time of flight (ToF) sensor data to enable enhanced image processing, the method comprising:
acquiring depth data for an object imaged by a ToF sensor;
acquiring additional data for the object imaged by the ToF sensor;
applying an image processing algorithm to process the depth data and the additional data; and
tracking object movement based on the processed depth data and the processed additional data.

2. The method of claim 1, wherein the additional data is amplitude data.

3. The method of claim 2, wherein the image processing algorithm includes: a depth data processing algorithm and an amplitude data processing algorithm, wherein the amplitude data processing algorithm isolates the object from a background.

4. The method of claim 1, wherein the additional data is intensity data.

5. The method of claim 4, wherein the image processing algorithm includes: a depth data processing algorithm and an intensity data processing algorithm, wherein the intensity data processing algorithm isolates the object from a background.

6. The method of claim 3, further comprising acquiring intensity data for the object imaged by the ToF sensor, wherein applying an image processing algorithm further processes the intensity data, and tracking object movement is further based on the processed intensity data.

7. The method of claim 1, further comprising processing an output of the image processing algorithm to decide whether the object performed a given gesture.

8. The method of claim 1, wherein the imaging processing algorithm:
generates a mask from the depth data;
uses the mask to remove background data from an amplitude frame;
compares one or more amplitude features of the object with pre-determined features to determine two-dimensional positions of one or more object elements; and
samples the three-dimensional (3D) position of each element from the depth data.

9. The method of claim 8, wherein the image processing algorithm further generates a 3D skeleton based on the 3D position of each element.

10. An apparatus for tracking an object, the apparatus comprising:
a depth sensing module configured to acquire depth data of an object;
a first sensing module configured to acquire a first data of the object; and
an image processing module configured to process the depth data and the first data to perform three dimensional tracking of the object.

11. The apparatus of claim 10, wherein the first data is amplitude data.

12. The apparatus of claim 11, further comprising an intensity sensing module configured to acquire intensity data of the object.

13. The apparatus of claim 10, wherein the first data is intensity data.

14. The apparatus of claim 10, further comprising an image data classifier module configured to isolate the object from a background.

15. The apparatus of claim 10, further comprising an image data tracker module configured to track a movement of the object.

16. The apparatus of claim 10, further comprising an output module configured to transfer tracking data to a user application.

17. An apparatus for performing enhanced user tracking, the apparatus comprising:
means for depth data sensing;
means for additional data sensing;
means for identifying movements made by a user and tracking the movements using the sensed depth data and the sensed additional data.

18. The apparatus of claim 17, wherein the means for additional data sensing senses amplitude data.

19. The apparatus of claim 18, further comprising means for intensity data sensing, and wherein the means for identifying movements made by a user and tracking the movements further uses the sensed intensity data.

20. The apparatus of claim 17, wherein the means for additional data sensing senses intensity data.
